(19) United States
(12) Patent Application Publication
(10) Pub. No.: US 2006/0085960 A1
(43) Pub. Date: Apr. 27, 2006

(54) Bead spinning apparatus with twisting device top

(76) Inventors: Dianne C. O'Keefe, Chesapeake, VA (US); Joseph E. O'Keefe, Chesapeake, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/971,655

(22) Filed: Oct. 22, 2004

(51) Int. Cl. B23P 19/04

(52) U.S. Cl. 29/241

(57) ABSTRACT

A bead spinning apparatus for quickly assembling beads onto a wire or string and includes a twisting device. The twisting device includes a sleeve or collar that tightens jaws that may be used to hold wires, posts, dowels or other such materials and implements used in the manufacturing of jewelry. The bead spinning apparatus includes a rotatable bowl affixed atop a base for receiving a plurality of beads to be threaded onto a wire or fiberous string. A base shaft extends upward from the base. The bowl includes a central shaft and a twisting device. The central shaft has an inner diameter that is larger than an external diameter of the base shaft for accommodating the base shaft. A ball bearing is disposed atop the base shaft within the central shaft. The rotatable bowl may be easily disengaged from the base and another rotatable bowl may be substituted.

There are no related patent applications.

This application did not receive any federal research and development funding.

### BACKGROUND OF THE INVENTION

The present invention relates generally to a bead spinner apparatus with a twister device for use in easily stringing large strands of beads onto a string of cloth or wire in a short amount of time. It is used in bead knitting, bead crocheting, loom weaving, making beaded flowers, and twisted fibers and the like. More specifically, the invention relates to a bead spinner including a twisting device that secures a wire or thread for creating a stem or larger diameter piece of wire or thread.

For purposes of the present application, the terms thread(s), fiber(s), wire(s), tape(s) and string(s) are used interchangeably and should be interpreted broadly to include a filament, cord, line or the like. For many years, people have created jewelry and clothing by assembling beads onto strings of cloth or pieces of wire. The beads used for creating jewelry and clothing are formed from a variety of materials and are provided in various sizes and colors. Typically, these beads are spherical in shape and include a through-hole or aperture for accepting an end of a wire, string, needle, hook or the like. The beads are assembled in a desired pattern by passing an end of a string through the hole of each bead. This technique of assembling beads to create jewelry, or the like, is a very time consuming process.

There has been a need for many years in the art of jewelry making for providing a method and apparatus that allows the user to easily and quickly assemble beads onto a string. U.S. Pat. No. 3,545,069 to Krieger discloses a technique for restringing a row of beads already supported on a thread. In Kreiger, the original thread supporting the beads is held tautly to align the holes of the beads. A wire is anchored to the thread and pulled through the apertures such that the beads are arranged on the wire. While Kreiger does teach a method of quickly reassembling onto a thread; he does not teach a quick way for initially assembling individual beads onto a string or wire

Tomita et al., U.S. Pat. No. 4,280,266, incorporated herein by reference thereto, discloses an automatic bead threading toy for threading beads upon a thread or line. A container for beads is mounted to a chassis. Beads fall from the container in a single fashion as the container is shaken by a hand actuated crank and ratchet assembly. A first end of a guide wire is mounted in the center of the outlet port. Thus, the beads fall one-by-one through the outlet port onto the guide wire. This toy includes many moving parts which are subject to failure with extensive use.

Ho, U.S. Pat. No. 4,785,521, incorporated herein by reference thereto, discloses a method for automatically linking beads. A thread is fastened at one end onto a straight elongated magnetic member and at the other end onto a stationary fixture. A magnetic block is positioned near the elongated magnetic member so that the member is attracted by the magnetic block in an upward direction to create a working space. The beads feed into the working space one-by-one while their through holes align with the free end of the elongated magnetic member. The beads automatically sleeve onto the elongated magnetic member and slide downward along the thread.

Another example of a device for assembling a plurality of beads onto a string is Yuen U.S. Pat. No. 5,197,175, incorporated herein by reference thereto. Yuen discloses a rotating bead stringing apparatus that includes a rotatable bowl for accepting beads therein. The bowl is rotated such that randomly oriented beads align with a fish-hook shaped needle to thread the beads onto a string or wire.

### BRIEF SUMMARY OF THE INVENTION

In the present invention, a bowl for receiving beads to be threaded onto a string includes a central shaft equipped with a ball bearing seat. The central shaft extends through the bottom of the bowl for receiving a base shaft. The exterior of the central shaft acts as a handle for spinning the bowl. By twisting the central shaft, both the central shaft and the bowl spin atop a base shaft extending from a fixed base. Alternatively, the central shaft may be removeably affixed within a shaft seat that protrudes upward from a bottom of the base. A twisting device is affixed atop the central shaft for twisting, braiding or winding coils of string or wire. The twisting device rotates along with the central shaft as it spins.

The bowl includes an opening, a bottom and a sidewall. The sidewall includes a lip that defines the opening. The lip prevents the beads from climbing the sidewall and spilling from the bowl while the bowl is spinning. The opening is large enough to permit a plurality of beads to be loaded into and removed from a coffer area defined by the sidewalls, bottom and lip. A central shaft having at least a hollow portion and solid portion extends through the center of the bottom of the bowl and upwards through the opening. The bowl shaft may be fastened to the bowl where it passes through the bottom of the bowl via an adhesive. A lower end of the shaft is arranged to easily slip the rotatable bowl onto the shaft that extends from the base mentioned below. Otherwise, a grommet may be sleeved onto the exterior of the central shaft and thereafter passed through the hole at the bottom of the bowl to fasten the bowl to the shaft. An upper end of the bowl shaft is solid and includes internal threads for receiving an externally threaded portion that affixes a twist device. Thus the upper end of the bowl shaft defines a threaded receptacle. In an alternative embodiment, the central shaft extends sufficiently downward into a shaft seat protruding from the bottom of the base. A ball bearing is disposed between the central shaft and the shaft seat such that the central shaft rotates relative to the shaft seat and base.

The twist device is affixed at the top of the central shaft and comprises a knurled collar that serves to adjust the opening and closing of a set of pin jaws that receive a wire or a jewelry making tool. These jaws comprise a pin device that includes a threaded portion that passes through the collar and threads into a central shaft. By adjusting the number of threads that are threaded into the central shaft, the collar may be loosened to open the jaws for receiving and removing wires, strings or other implements for use in at least the art of jewelry manufacturing. However, it should be understood that the twisting device or braiding tool mentioned in the present invention may be applied for use in other industries.

The base is preferably pedestal in nature. In one embodiment, a base shaft extends from the center of the bottom of the base and extends into the hollow shaft. A ball bearing is disposed between the top of the base shaft and the ball bearing seat included in the solid portion of the central shaft to allow the bowl shaft to more freely spin about the base shaft. Otherwise the base may be pedestal in shape similar to the Yuen device mentioned above.

The present invention comprises a bowl for receiving beads to be threaded onto a string. The bowl may include a mandrel affixed to a center of the bowl for spinning the bowl atop a bearing situated atop a fixed base. A wire twisting or holding device is affixed atop of the handle that spins the bowl. A fixed base may include a recess for accommodating the remaining portion of the ball bearing. In a further embodiment, the fixed base includes a central shaft for accommodating the ball bearing.

### BRIEF DESCRIPTION OF THE DRAWINGS

FIG. 1 is a perspective view of a bead spinning apparatus showing the twist device retaining a twisted wire or string.

FIG. 2 is a partial exploded view of a first and second embodiment of the bead spinning apparatus, respectively.

FIG. 3 is a cross section elevation of the embodiment of the bead spinning apparatus of the present invention.

FIGS. 4A and 4B show an exploded view and a cross section view of an embodiment of the twist device, respectively.

FIGS. 5A and 5B are overhead plan views of different embodiments of the twist top.

FIG. 6 is a partially cutaway top plan view of the bead spinning apparatus shown in use.

FIGS. 7A through 7C depicts views of a jig or tool for use with the twisting device of the present invention.

### DETAILED DESCRIPTION OF THE INVENTION

The following is the preferred embodiment or best mode for carrying out the invention. It should be noted that this invention is not limited by the discussion of the preferred embodiment.

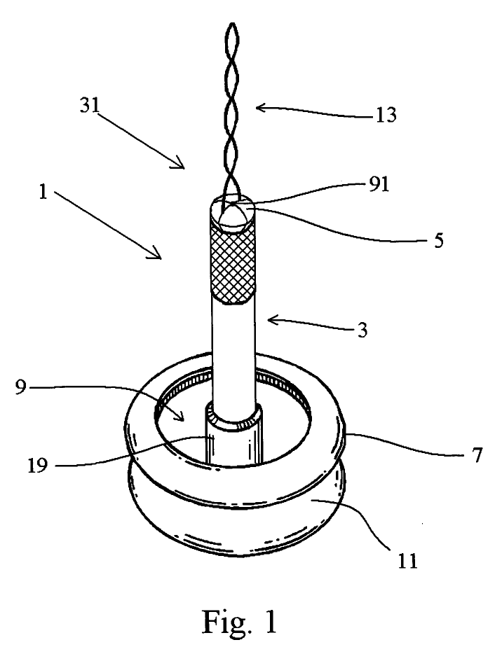

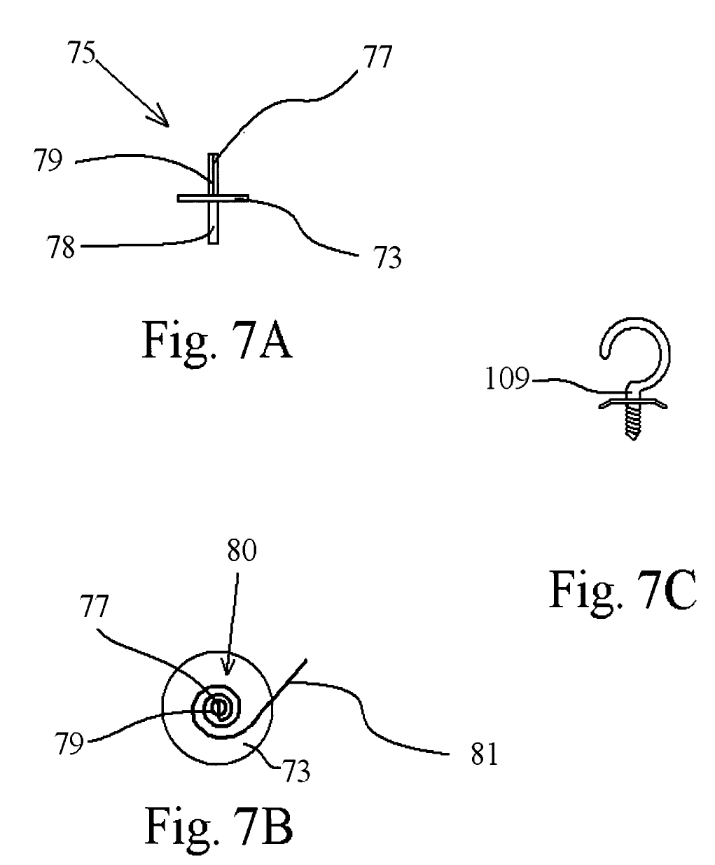

FIG. 1 is a perspective view of the bead spinning apparatus 1 including a twisting device 31 that comprises a plurality of jaws 5. Ends of a twisted wire 13 are secured in the jaws 5. The twisting device 31 is affixed at an upper end of the central shaft 3 which extends through central portion 19, as shown. A rotatable bowl 7 includes an interior 9 for accommodating a plurality of beads to be strung onto a wire as shown in FIG. 7. The rotatable bowl 7 rotates relative to base 11. Jaws 5 include a dimple 91 for accommodating tools and the like.

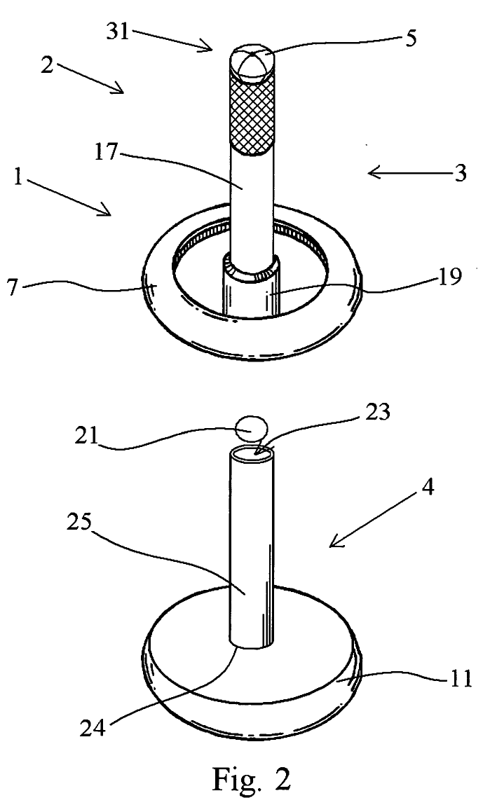

FIG. 2 is an exploded view of an embodiment of the present invention. This embodiment includes an upper subassembly 2 and a lower subassembly 4. The upper subassembly 2 includes the rotatable bowl 7 and central shaft 3. The bowl may include a central portion 19 that extends from the bottom of the bowl 7 and through which central shaft 3 passes. The central shaft 3 comprises a section 17 for use in spinning the bowl 7. The interior diameter of central shaft 3 is sufficiently large to accommodate base shaft 25 as shown. The lower subassembly 4 includes base shaft 25 extends from the center of base 11 upwards and includes a ball bearing seat 23. A ball bearing 21 is disposed between base shaft 25 and central shaft 3. Base 11 includes a shaft seat 24 into which an end of base shaft 25 is fixed.

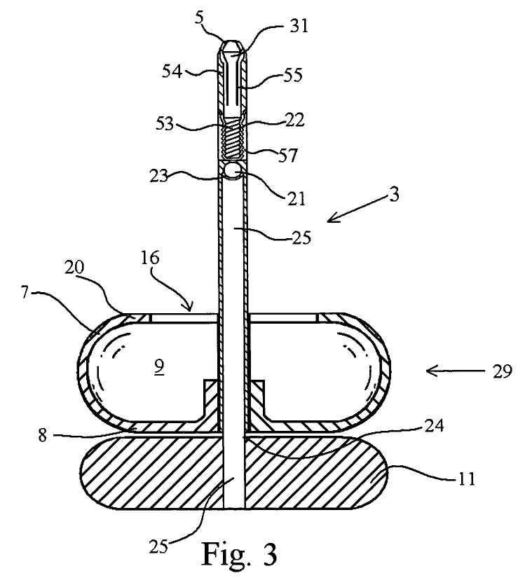

FIG. 3 corresponds to the embodiment shown in FIG. 2. Twisting device 31 is affixed at an upper end of the central shaft 3 via threads 22.

In FIG. 3, an upper end of central shaft 3 rests atop the ball bearing 21. The interior shape of the upper end may comprise a bearing seat similar to bearing seat 23 for accommodating the bearing 21.

In FIG. 3, ball bearing 21 is seated below twisting device 31 and atop base shaft 25 within central shaft 3. The rotatable bowl 7 includes an upper lip 20 and an opening 16 for providing access to interior 9 defined by sidewall 29 and bottom 8. In the preferred embodiment, the base shaft 25 is long enough such that a distance is maintained between the bottom 8 of bowl 7 and base 11.

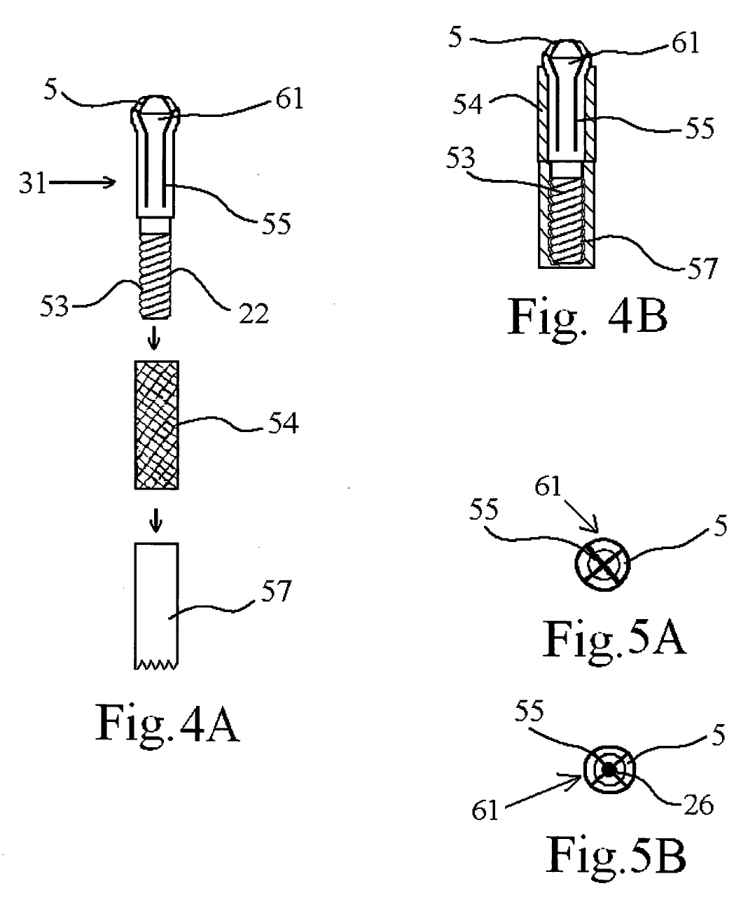

In the embodiment of the twisting device 31 shown in FIGS. 4A and 4B, the twisting device 31 includes a head 61 that includes slots 55. A lower end 53 comprises external threads 22. Lower end 53 passes through collar 54 and into threaded upper end 57 of shaft 3. As head 61 is threaded into upper end 57, collar 54 compresses slots 55 which in turn cause jaws 5 to be closed as shown in FIG. 4B.

FIGS. 5A and 5B are overhead plan views of the head 61. In these figures, the head 61 includes four jaws 5 that are separated by slots 55. A central hole 26 is provided for accommodating larger gauge wires or small diameter screws such as on a cup hook, a jig hook 109 or other such tool as depicted in FIG. 7C.

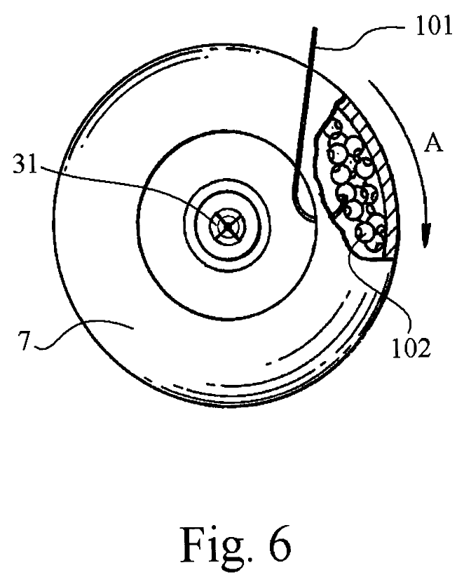

FIG. 6 shows how beads may be strung onto a hook 101 that has been formed by wrapping an end of the wire around the exterior of the vertical shaft. Hook 101 is inserted into bowl 7 as it rotates. Holes in beads 102 randomly align with an end of hook 101 and are threaded thereonto as the bowl 7 rotates. Arrow A shows the direction of rotation of twisting device 31 and bowl 7, respectively.

FIGS. 7A and 7B depict views of a jig or tool 75 for use with the twisting device 31. The tool 75 includes an upper extension 77 that extends from a platform 73 and includes a slot 79 for securing an end of a piece of wire or tape 81 to create a scroll 80. A lower extension 78 extends downward from the platform 73 to be inserted into jaws 5 of the twisting device 31. As shown in FIG. 7B, an end of the tape 81 is inserted into slot 79. The twisting device 31 secures the lower extension 78. The scroll 80 is created by spinning the twisting device 31 as mentioned above. FIG. 7C shows a hook 109 that may be inserted into the twisting device 31.

It is to be understood that the invention is not limited to the exact construction illustrated and described above, but that various changes and modifications may be made without departing from the spirit and the scope of the invention as defined in the following claims.

1. A bead spinning apparatus comprising:
a rotatable bowl comprising a sidewall, a bottom and a lip that defines a coffer area for receiving a plurality of beads to be assembled onto a string;
a central shaft extending through the bottom of the rotatable bowl;
a twisting device having at least one set of adjustable jaws and affixed to said central shaft; and,
a base connected to said rotatable bowl via said central shaft.

2. The bead spinning apparatus of claim 1 wherein said central shaft includes a solid portion that comprises internal threads.

3. The bead spinning apparatus of claim 1 wherein said twisting device comprises a collar for tightening the set of adjustable jaws affixed to the twisting device to an upper end of the central shaft.

4. The bead spinning apparatus of claim 1 wherein said twisting device comprises a head that includes the one set of adjustable jaws and a threaded portion that passes through a collar to thread into the central shaft.

5. The bead spinning apparatus of claim 1 wherein said base includes a shaft seat for accommodating an end of said central shaft.

6. The bead spinning apparatus of claim 1 further comprising a base shaft affixed to said base for mating with a hollow portion of said central shaft.

7. A bead spinning apparatus comprising:
a rotatable bowl comprising a sidewall, a bottom and a lip that defines a coffer area for receiving a plurality of beads to be assembled onto a string;
a central shaft extending through the bottom of the rotatable bowl and said central shaft further including a hollow portion and a solid portion, said solid portion arranged with internal threads atop the hollow portion and including a ball bearing seat for receiving a ball bearing;
a twisting device having at least one set of adjustable jaws and affixed to said central shaft;
a collar disposed between said twisting device and said central shaft;
a base connected to said rotatable bowl; and
a ball bearing disposed within said ball bearing seat.

8. A bead spinning apparatus comprising:
an upper subassembly including a rotatable bowl, a central shaft with a twisting device affixed to said central shaft;
a lower subassembly including a base and a base shaft extending from a center of the base and including a ball bearing seat.

9. The bead spinning apparatus of claim 7 further comprising a ball bearing disposed between said base shaft and the bowl shaft.

10. The bead spinning apparatus of claim 7 wherein said base includes a shaft seat into which an end of the base shaft is fixed.

11. The bead spinning apparatus of claim 7 further including a bowl that comprises a central portion extending from a bottom of the bowl and through which the central shaft passes.

12. The bead spinning apparatus of claim 7 wherein an interior diameter of a central shaft is sufficiently large to accommodate the base shaft.

13. The bead spinning apparatus of claim 7 further comprising a pin vise threaded onto the central shaft.

14. The bead spinning apparatus of claim 7 further comprising a central shaft includes an interior threaded to accept a pin vise.

15. The bead spinning apparatus of claim 7 further comprising a knurled collar to tighten slots of pin vise.

16. The head of pin vise of claim 13 further comprising a central hole in the pin vise to accept one of a small rod, screw, or wire.

17. The bead spinning apparatus of claim 7 further comprising a ball bearing being fixed to the base shaft.

18. The bead spinning apparatus of claim 7 further comprising a tool secured within the twisting device selected from a group consisting of a hook and a jig.
